(19) United States
(12) Patent Application Publication
(10) Pub. No.: US 2012/0193366 A1
(43) Pub. Date: Aug. 2, 2012

(54) Flexible Foam Beverage Holder

(76) Inventor: Justin Miller, Silver Creek, NY (US)

(21) Appl. No.: 13/286,286

(22) Filed: Nov. 1, 2011

Related U.S. Application Data
(60) Provisional application No. 61/436,795, filed on Jan. 27, 2011.

(51) Int. Cl. A47J 41/00; B65D 83/72

(52) U.S. Cl. 220/592.17; 220/592.24; 220/739; 62/372

(57) ABSTRACT

An insulated beverage device comprising a self-skinning flex foam construction, adapted to maintain a beverage temperature for extended periods. The present invention may be utilized as an insulator for a beverage container, such as a bottle or a can, or the present invention may be used as an insulated drinking cup, wherein the beverage is poured directly thereinto. The device features an ice storage compartment at its base where a user can store ice. A user may then place a beverage container above the ice compartment for refrigerated storage. The ice reduces or maintains the internal temperature of the beverage resting thereabove, while the foam construction of the device insulates the ice and beverage from outside temperatures. The device can also contain hot beverage storage containers as well, such as disposable coffee cups. Hot water can be stored in the storage compartment instead of ice.

### CROSS REFERENCE TO RELATED APPLICATION

This application claims the benefit of U.S. Provisional Application No. 61/436,795 filed on Jan. 27, 2011, entitled “The Chill-Z.”

### BACKGROUND OF THE INVENTION

1. Field of the Invention

The present invention relates to an insulated beverage holding device for keeping beverages at a desired temperature until an individual is ready to consume the beverage contained therein. More specifically, the present invention may either insulate a beverage contained in a storage container, such as a bottle or a can, or the present invention can be used as an insulated drinking cup. The construction of the device is that of self-skinning flex foam that provides an outer shell with interior insulating properties.

2. Description of the Prior Art

Many individuals enjoy a cool drink on a hot day and can appreciate a well insulated beverage holder for keeping their drink at a desired temperature prior to consumption. Traditional methods for keeping a beverage cool involve adding ice to the beverage or freezing the beverage itself and allowing the beverage to slowly thaw during consumption. The problem with ice cubes is that as the ice melts, it can dilute the beverage, reducing the overall quality of the beverage and depreciating the level of satisfaction associated with the beverage. If an individual freezes the whole beverage, allowing it to gradually thaw during consumption, the drinker can run into a variety of problems. For example, it is possible that the beverage will not thaw quickly enough to satisfy the drinker's thirst. The drinker must also have the foresight to place a beverage in a freezer overnight such that it is prepared for the following day, which can be inconvenient if the individual forgets to prepare and freeze the beverage ahead of time. Not only that, if the desired beverage is contained in a rigid, sealed container, and further if it is carbonated, these types of beverage containers cannot be placed in the freezer overnight as they run the risk of breaching the container seal as a result of the freezing cold temperature expanding the liquid contained therein. Carbonated beverages are of particular concern, as the breach in the container causes a rapid expansion of gas that rapidly opens the breach and causes an ‘explosion’ of contents therefrom.

Other options include storing beverages in a cooler; however coolers tend to be often bulky, heavy and not particularly suited for the given task of transporting a single beverage in a controlled environment. Furthermore, a cooler may keep a beverage cool until an individual is ready to be consumed, however, once the beverage has been removed from the cooler, it will gradually warm to ambient temperature. Very often an individual cannot consume the whole contents of a beverage before the beverage warms. The solution for preventing a beverage from warming is to implement some sort of insulated beverage device that will keep the contained beverage cold and refreshing.

Several patents have been granted to devices that attempt to provide a user with an insulated beverage holder. These prior art devices have several known drawbacks. Some of the devices insulate only a portion of a canned or bottled beverage container, leaving some of the canned or bottled beverage container exposed to the atmosphere and ambient temperature. Other existing devices are bulky, inconvenient or difficult to manipulate during use. For example, U.S. Pat. No. 6,588,621 to Shimazaki describes an insulated drinking cooler for storing a bottled beverage during consumption. A user inserts a bottled beverage inside of an insulated cup with a handle. The design of the cup allows for insulating spaces to exist inside the device, between the inserted beverage container and the interior walls of the device. These insulating spaces are filled with ice, or iced water, by a user to keep the bottled beverage cool during consumption. The device describes two main means of sealing the insulating cavity of the device once a bottled beverage has been inserted into the device. Either the top of the device features a watertight gasket that fits around the bottle—sealing the insulating ice or iced water inside the insulating cavity and leaving approximately the top quarter of the bottled beverage exposed to ambient temperature, or the device utilizes a cap which allows only the bottled beverage's pouring spout to be exposed to the atmosphere—more thoroughly insulating the entire contents of the bottled beverage. The device can be manufactured in a variety of sizes and shapes to accommodate different bottles of various volumes.

The Shimazaki beverage insulating device is bulky by design and is not intended for use with those beverage containers that are not bottles. The Shimazaki device would be ideal for use by any individual who works outdoors all day, requiring large quantities of liquid for hydration and therefore requiring a device with ample volume to store such a large beverage cooling device; however, the large size and bulky design of the device makes it impractical for use in many outdoor social or transit situations where space on an outdoor table or within a vehicle is limited. The present invention utilizes an insulating flex foam skin for holding a beverage and has an insulated ice storage compartment at the bottom of the device. A user places ice into the ice storage compartment and then places a beverage container above the inserted amount of ice. The present invention can hold both bottled beverages and canned beverage containers.

Similarly, U.S. Pat. No. 4,255,944 to Gardener describes a wine bottle insulating and holding device with an ice compartment at its base. This device is limited to holding only wine bottles. The device is a large cylinder having an insulating space in a wall of the device that a user fills with ice or iced water. A user also places ice at the bottom of the device in an ice storage compartment. While the device is filled with ice, it chills a bottle of wine for an extended period of time. The device is designed to leave the neck of the inserted wine bottle exposed to the atmosphere such that a user may easily grab the wine bottle by its exposed bottle neck and remove the bottle from the device to pour wine into glasses for consumption, as it is not customary for an individual to drink directly from a wine bottle.

U.S. Pat. No. 6,101,838 to Teague describes an insulated mug with a handle for holding beverages that are poured into the insulated beverage containing cavity thereof. The insulated space contains an insulating, chilling material that keeps the beverage cool. A user can either pour a beverage directly into the beverage containing cavity of the device, or can fit a canned beverage thereinto. Similarly, U.S. Pat. No. 3,302,427 to Stoner describes an insulated can holder mug with a handle. The Stoner device also has an insulated space which contains an insulating material to keep the contained beverage cool. The Stoner device is capable of holding a beverage directly in the beverage containing cavity, or in the alternative, the device can hold a canned beverage container. The major difference between the Stoner device and the Teague device is that the Teague device has an insulating material that also serves as a chilling material. Neither the Teague nor Stoner device is for use holding bottled beverage containers. The present invention allows a user to hold and insulate a canned or bottled beverage, or in the alternative, an individual may use the present invention as an insulated drinking cup, wherein a beverage has been directly poured into.

U.S. Pat. No. 6,145,685 to Dick describes an insulated thermos that requires a user to fill the device with a beverage. A user cannot place a canned or bottled beverage into the insulated thermos device. Rather, a user must pour the contents of the canned beverage into the device in order to drink therefrom. While the it may be useful and convenient as a receptacle to transfer a beverage that is originally stored in a pitcher or larger beverage container that would otherwise be impossible to drink from, the device is not suited for beverages that are available in easy to drink forms, such as cans or bottles. The present invention enables a user to hold an individually-sized canned or bottled beverage in an insulating skin. The canned or bottled beverage sits above an ice storage compartment while providing insulation and a compartment of cooling or heating means therein.

U.S. Pat. No. 6,786,062 to Greenberg describes a beverage coaster with a cooling member incorporated into the base of the coaster and insulting side walls. The cooling member is contoured in shape to better fit and receive a canned beverage container. The cooling member is located at the base of the canned beverage to facilitate cooling the remaining unconsumed portion of the beverage until consumed. The Greenberg device only insulates the base of a canned beverage, leaving a majority of the canned beverage exposed to the ambient air therearound, reducing the time the device will stay at a chilled temperature. The lack of coverage around the remaining surface area of the beverage allows a large quantity of thermal energy to transfer thereinto and increase the temperature of its contents. The present invention employs an insulating skin that fits around the base and side walls of the beverage container, insulating the whole beverage, retaining its desired temperature for extended period of time.

The present invention substantially therefore sufficiently diverges in design elements from the prior art and consequently it is clear that there is a need in the art for an improvement to existing insulating beverage holding devices. In this regard the instant invention substantially fulfills these needs by providing a self-skinning flex foam beverage holder that provides insulation around the lower exterior of a beverage container, or around a volume of fluid contained therein. The holder further provides a volume at its interior base to allow for ice cubes, hot water or alternative thermal means in order to retain, lower or raise the temperature of the contents of a beverage container placed into the device.

### SUMMARY OF THE INVENTION

In view of the foregoing disadvantages inherent in the known types of insulating beverage holding devices now present in the prior art, the present invention provides a new insulated beverage container holding device wherein the same is made from an insulating, self-skinning flex foam material that fits snuggly to the exterior of a beverage container. The beverage container is placed on top of an ice storage compartment within the device, or alternatively the device functions as a cup itself. The ice compartment is provided to cool the contained beverage within the device.

It is therefore an object of the present invention to provide a new and improved insulating beverage holding device that has all of the advantages of the prior art and none of the disadvantages.

It is also an object of the present invention to provide a user with a means of keeping a beverage cold without having to introduce ice cubes into the beverage.

Another object of the present invention is to provide a user with an improved grip on the device by providing an insulating material that prevents condensation from forming along its exterior surface.

Another object of the present invention is to provide a device that can function as an ice holding, insulating koozie for a beverage container, or an insulated beverage cup.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 is a perspective view of the present invention wherein a canned beverage rests within the beverage container device. The ice cube compartment is positioned below the beverage container and is filled with ice.

FIG. 2 is a perspective view of the present invention with ice being added to the ice compartment of the device prior to placement of a beverage container or a beverage directly.

### DETAILED DESCRIPTION OF THE INVENTION

Reference is made herein to the attached drawings. Like reference numerals are used throughout the drawings to depict like or similar elements of the beverage insulating device. For the purposes of presenting a brief and clear description of the present invention, the preferred embodiment will be discussed as used for chilling and insulating a beverage container. The figures are intended for representative purposes only and should not be considered to be limiting in any respect.

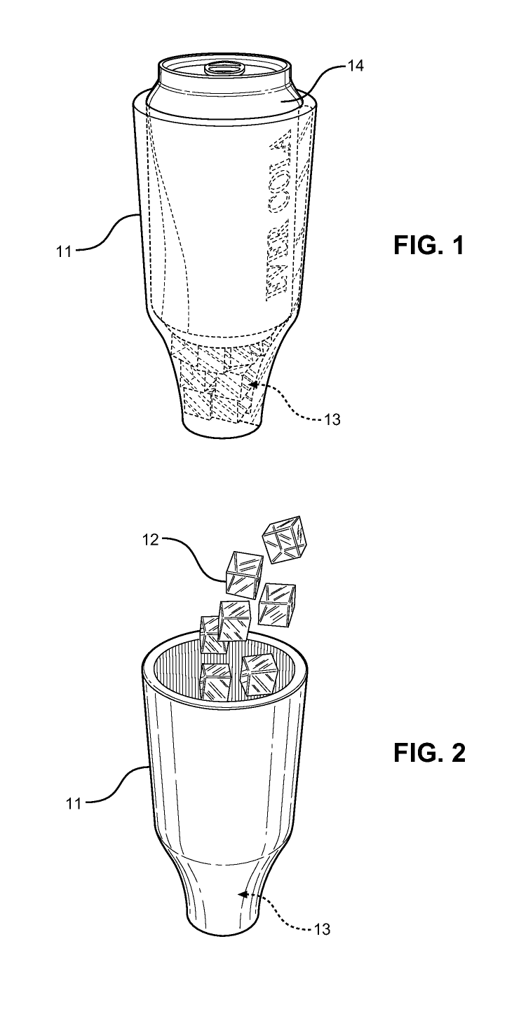

Referring now to FIG. 1, there is shown a perspective view of the present invention wherein a canned beverage container rests within an insulating, chilling beverage device. The present invention comprises a flexible insulating skin 11 that fits around a beverage container to provide thermal insulation and allow chilling or heating means to be applied to the beverage container. The insulated beverage container holder 11 comprises a largely cylindrical shape, having a closed bottom 13 and an open top and a continuous side wall. The device also has an open interior volume adapted to fit a beverage container, along with sidewalls that are flexible to expand to different sized or oddly shaped beverage containers. The insulated beverage holder 11 exterior side wall can be manufactured in a variety of sizes, shapes, colors and designs such that a user may choose an insulated beverage holder device that suits the needs and aesthetic preferences of a user. The bottom of the insulated beverage holder 13 may have smaller circumference than its open top, providing a means to fit the device into smaller cup holders. This bottom portion comprises a thermal cooling or heating storage compartment to provide a means of retaining or altering a beverage to a desired hot or cool temperature. The bottom portion may be filled with ice to cool a beverage or hot water, as desired by the user.

One embodiment of the present invention is constructed from a self-skinning, flex foam material. During the manufacturing process of the device, this self-skinning foam is injected into molds that are in the shape of the beverage holding device. As the foam expands to fill a mold, areas of the foam that make contact with the interior surface of the mold form a continuous skin that resembles a plastic surface. The foam insulating material prevents condensation from forming on the exterior of the device, which improves the user's grip on the device as there is no condensation on the device making the exterior surface slippery. The flex foam provides a comfortable grip for the user, and an insulating material to prevent heat loss or introduction into the beverage held therein.

The device is not limited to holding and insulating canned beverage containers; the device is also capable of holding and insulating bottled beverage containers. If so desired by a user, the device may also be used as an insulated cup, which a user can pour a beverage directly thereinto and drink therefrom. The insulating nature of the device keeps the beverage cooler for longer than a traditional, non-insulated drinking cup.

Referring now to FIG. 2, there is shown a perspective view of the present invention. In use, an individual places ice cubes 12 along the bottom of the beverage holding device within the ice compartment 13, and then places a canned or bottled beverage 14 on top of the ice-filled ice compartment. The insulating material, which the device is constructed from, keeps the contained beverage cool during consumption. The preferred embodiment of the present invention is a beverage holding device that incorporates self-skinning flex foam designed to insulate beverages. A device of this material may hold hot beverage containers, such as disposable coffee cups or similar heated beverages. Instead of filling the ice compartment with ice, an individual can fill the compartment with hot water and place a hot beverage cup on top of the hot water storage compartment. The hot water transfers heat to the contained cup, but does not burn the user since the skin of the device fits snuggly against the sides of the contained cup, forming a seal to keep the hot water inside the hot water storage compartment.

Overall, the present invention provides a device that can house a beverage container and maintain or adjust its temperature without exposing the user to any extreme temperatures. The base of the device is adapted to fit a thermally cooling or heating means, such as ice cubes or hot water, while the self-skinning flex foam material provides a means to insulated the beverage, hold it snuggly in place and provide the user with a soft, graspable exterior surface that resists condensation buildup.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) An insulated beverage holding device, comprising:
an insulated beverage holder having a closed bottom, an open top and a sidewall,
said insulated beverage holder further comprising an interior volume and an exterior sidewall surface;
said insulated beverage holder having a storage compartment located within said base, adapted to house a thermally cooling or heating means.

2) The device of claim 1, further comprising said beverage holder sidewall having a cylindrical shape.

3) The device of claim 2, further comprising said cylindrical sidewall having base with a smaller circular circumference than said open top circumference.

4) The device of claim 1, wherein said thermally cooling means comprises ice.

5) The device of claim 1, wherein said insulated beverage holding device is made from insulating flexible foam.

6) The device of claim 5, wherein said insulating flexible foam is a self-skinning foam.
